(19) United States
(12) Patent Application Publication
(10) Pub. No.: US 2009/0277699 A1
(43) Pub. Date: Nov. 12, 2009

(54) POWER-GENERATING PLUG-AND-PLAY VEHICLE

(76) Inventor: Terng-Jou WAN, Taipei (TW)

Correspondence Address: Muncy, Geissler, Olds & Lowe, PLLC, P.O. BOX 1364, FAIRFAX, VA, 22038-1364, US

(21) Appl. No.: 12/251,038

(22) Filed: Oct. 14, 2008

(30) Foreign Application Priority Data
May 12, 2008 (TW) 097208187

(51) Int. Cl. B60K 16/00

(52) U.S. Cl. 180/2.2

(57) ABSTRACT

A power-generating plug-and-play vehicle is provided, which includes a main vehicle body, a plurality of solar cell units coupled to the vehicle, a gear-driven power unit, a power storage unit, an accelerator unit and a drum-motor-driven power unit. The plurality of solar cell units are capable of converting solar energy to electrical energy, which is in turn stored in the power storage unit. The gear-driven power unit converts mechanical energy to electrical energy, which is also stored in the power storage unit. The accelerator unit and the drum-motor-driven power unit convert between mechanical energy and electrical energy, thereby appropriately adjusting the means for driving the main vehicle body. The plurality of solar cell units may be removed and the angle at which the solar cell panel is mounted may be adjusted via gearing of the solar cell panel and the gear-driven power unit. Wind energy may be converted to electrical energy while the vehicle is in motion, and the electrical energy is stored in the power storage unit.

### BACKGROUND OF THE INVENTION

1. Field of the Invention

The present invention relates to vehicles, and more specifically to a power generating plug-and-play vehicle.

2. Description of Related Art

In order to promote healthy exercises as well as the power saving concept, bicycle, electric bicycle, electric car, and motorized scooter have been gradually becoming the focus of the relevant industries due to their characteristics such as power saving low noise and pollution. However, since electrical power is still required to run electric bicycle and electric car, therefore the drawbacks of the above-mentioned items are heavy weight, short operating hour, and inconvenience for outdoor use. In addition, the aforementioned vehicles must still be charged up using the electrical service provided by the city government (the electrical power eventually comes from power plants), and thus they do not comply with the “Green” principle. Moreover, prices of the above-mentioned items are still too high and thus, these vehicles are incompetent compared to traditional vehicles. As a result, most consumers are unwilling to purchase the above-mentioned products, which are therefore poorly visible on the market.

The aforementioned vehicles currently on the market are mostly powered by battery or motor generator. However, solar cell panel is sometimes used to generate electrical power, hoping to solve problems like air pollution and over-consumption of energy by using renewable energy for transportation.

However, vehicles powered by motors in direct contact with the wheel rotation have a poor efficiency, thus riding such vehicles is a strenuous effort to the riders. In addition, such vehicles consume electrical energy without regenerating them, and at the same time, there is only a limited amount of electrical power provided by the battery, therefore after the battery is depleted or exhausted, a new battery is either required to replace the old one or the depleted battery must be recharged. Besides, it is ineffective if the solar cell panel is used for power generation alone, as the panel converts solar energy into electricity on sunny days only, whereas on rainy days, the vehicles must be powered by other means as the solar cell fails to capture enough solar energy from sunlight.

Hence, it has become an urgent issue to find a new and environment-friendly technique that solves the above-described problems and at the same time uses multiple renewable energies to overcome the above drawbacks.

### SUMMARY OF THE INVENTION

In view of disadvantages of the above-mentioned technique, a primary objective of the present invention is to provide a power generating “plug-and-play” vehicle. Power is generated by utilizing renewable energy while the user is riding the vehicle and the generated electrical power is stored for future use. On rainy days, the vehicle of the present invention converts mechanical energy (kinetic energy) from the user to electrical energy, and the generated electrical energy is also stored for future use. Ultimately, the present invention allows the user to achieve the goal of exercising.

Another objective of the present invention is to provide a power-generating plug-and-play vehicle without emitting air pollutants (SO_{X}, NO_{X}) and greenhouse gas (GHG, i.e. CO₂) in order to protect the environment.

In order to achieve the above and other objectives, the present invention provides a power-generating plug-and-play vehicle including a main vehicle body having a gear-driven power unit, a power storage unit complied to the gear-driven power unit, and a plurality of power supply parts electrically connected to the power storage unit. A plurality of solar cell units are capable of capturing and converting solar energy from sunlight into electrical energy stored in the power storage unit, wherein each of the solar cell unit is removable and the angle at which each of the solar cell unit is installed on the main vehicle body is adjustable. In addition, the solar cell units operate in coordination with the gear-driven power unit, so as to facilitate the main vehicle body, while moving in tailwind condition, to convert wind energy to electrical energy, which is in turn stored in the power storage unit. The electrical energy stored in the power storage unit is then supplied to the installed power supply parts.

In comparison to the conventional technique, the present invention makes use of renewable energy (solar energy, manpower, wind, power, etc.) to generate electrical energy, which is in turn stored, for the electrical energy to power various electrical equipments installed on the vehicle. For example, by using an angle-adjustable solar cell unit, when the wind blows in the same direction as that of the course of a vehicle, the solar cell unit are adjusted such that they become a wind-powered generator for driving the vehicle. Extra energy is converted to electrical energy by the gear-driven power unit and the generated electrical energy is further stored. In addition, while pedaling the main vehicle body, the gear-driven power unit connected to the main vehicle body is activated to generate electric current. In another scenario when the vehicle moves downhill (without pedaling), the wheels of the main vehicle body are rotated automatically to activate the gear-driven power unit for electrical power generation. The above-mentioned electrical energy generated by both methods is consequently stored in the power storage unit.

### BRIEF DESCRIPTION OF DRAWINGS

FIG. 1 is a diagram illustrating a left view according to an embodiment of the present invention;

FIG. 2 is a diagram illustrating a front view according to an embodiment of the present invention; and

FIG. 3 is a diagram illustrating a back view according to an embodiment of the present invention.

### DETAILED DESCRIPTION OF PREFERRED EMBODIMENTS

The following embodiments further illustrate the points of the present invention in detail, however the scope of the invention is not limited to any points.

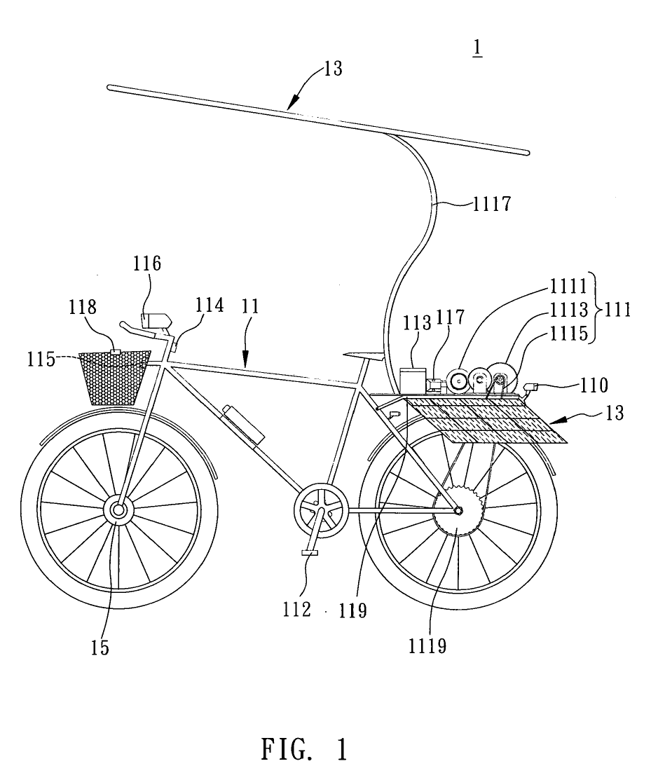

As shown in FIGS. 1 to 3, a power-generating plug-and-play vehicle according to an embodiment of the present invention is illustrated using a bicycle, which is merely exemplary and is not to be construed as limiting the present invention. The vehicle is selected from the group consisting of electric bicycle, electric car, motorized scooter and other transportation tools. The power-generating vehicle 1 according to the present embodiment includes a main vehicle body 11 and a plurality of solar cell units 13. As the components forming the bicycle, electric bicycle, motorized scooter or electric car are previously known, therefore the functions and their relationships will not be introduced here. Only parts related to the present embodiment will be illustrated.

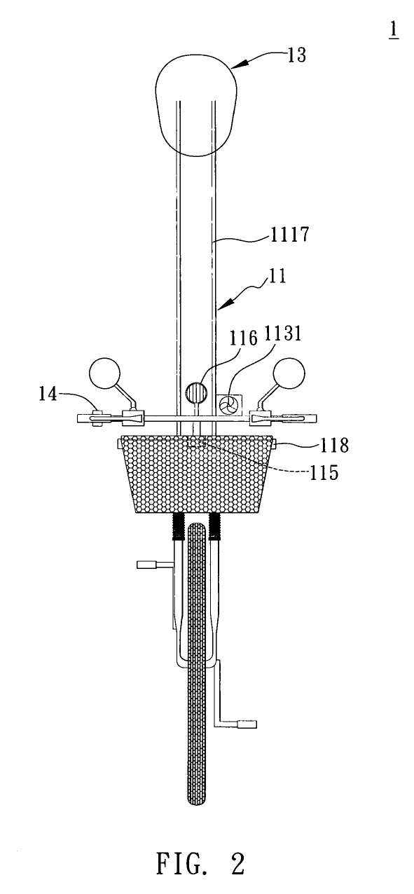

As illustrated in FIGS. 1 and 2, the main vehicle body 11 has a gear-driven power unit 111, a power storage unit 113 connecting the gear-driven power unit 111, a plurality of power supply parts 115, and an accelerator unit 14 electrically connected to the power storage unit 113. A commutator unit 117 and a controller IC (not shown in the diagram) are mounted to either the gear-driven power unit 111 or the power storage unit 113. The commutator unit 117 and the controller IC are electrically connected to the power storage unit 113. At least one of the two sides of the main vehicle body 11 is installed a mounting part 119, which is for mounting the solar cell unit 13. The accelerator unit 14 is mounted on the handle grip of the main vehicle body 11. For example, the accelerator mounted on the right handle grip is electrically connected to the power storage unit 113. In other embodiments, either the mounting location of the accelerator unit 14 is changed or the accelerator unit 14 is not mounted.

The gear-driven power unit 111 includes a power generator 1111, a gear train 1113 connected to the power generator 1111, a transmission part 1115 engaging the gear train 1113 as well as connecting the main vehicle body 11, and a supporting rod 1117 allowed to be freely mounted to or removed from the main vehicle body 11. An example of the power storage unit 113 is a battery. The plurality of power supply parts 115 may be selected from the group consisting of electrical charger, battery or other power supply components. In the present embodiment, an example of the power supply parts 115 is a USB port installed in the basket. A different number of power supply parts 115 are also installed at different locations. The supporting rod 1117 supports one of the solar cell units 13 above the main vehicle body 11. The mounting part 119 is used for mounting at least one solar cell unit 13 on one side of the main vehicle body 11.

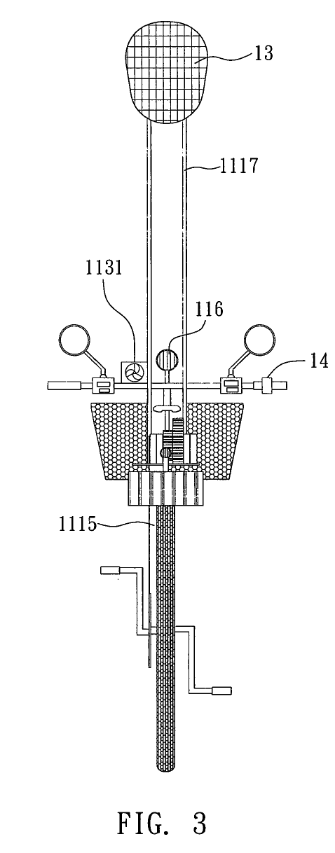

In the present embodiment, the main vehicle body 11 is mounted the supporting rod 1117 behind the seat set. The supporting rod 1117 shall be ergonomic. For example, an arc-shaped supporting rod not only supports the solar cell unit 13, but also provides a mechanism for the user to lean against while riding the vehicle. As shown in FIG. 2 and FIG. 3, the main vehicle body 11 is mounted a fan 1131 which is electrically connected to the power storage unit 113. The space above the rear wheel is for mounting the gear-driven power unit 111, which is electrically connected to the commutator unit 117, controller IC, voltage regulator (not shown in the diagram), and the power storage unit 113. Also, a pair of solar cell units 13 is installed on the two sides of the main vehicle body 11. In addition, a primary gear 1119 is installed at the cassette of the rear wheel. For instance, the chain of the transmission part 1115 engages the primary gear 1119 and gears of the gear train 1113. Besides, the vehicle 1 includes a pedal 112 installed on the main vehicle body 11, and the pedal 112 moves correspondingly with the transmission part 1115.

In addition, a battery power level indicator 114 installed at the front of the vehicle, an LED front light 116, an LED direction light 118, and an LED brake light 110 installed at the rear of the vehicle are electrically connected to the power storage unit 113.

The plurality of the respective solar cell units 13 may be electrically connected to a power storage unit 113 for capturing and converting energy from solar energy into electrical energy which is stored in the power storage unit, wherein the power storage unit 113 is electrically connected to the commutator unit 117. In the present embodiment, the solar cell unit 13 is removable and the angle at which the solar cell unit 13 is installed on the main vehicle body 11 is adjustable. In addition, the solar cell unit 13 operates in coordination with the gear-driven power unit 111, so as to allow the main vehicle body 11 to convert wind energy to electrical energy, which is in turn stored in the power storage unit 113. The electrical energy stored in the power storage unit 113 is then supplied to the installed power supply parts 115. In the present invention, the plurality of solar cell units 13 may include a plurality of solar panels and each solar panel is assembled with one another to form a surface body. In addition, the angle at which as well as the direction in which the solar cell units 13 on two sides of the main vehicle body 11 are placed are allowed to be adjusted freely. For instance, the solar cell units 13 are normally installed on the two sides of the vehicle 1 with the light-receiving surface facing upward. When the solar cell units 13 are allowed to be folded downward, so that the clothing or personal belongings of the rider are prevented from being drawn into the wheels. When moving in a tailwind condition, the solar cell units 13 are folded upward such that the vehicle 1 is driven more effectively by using strong wind power. At the same time, the transmission part 1115 engages the primary gear 1119 and the gear train 1113, thereby causing the power generator 1111 to generate an alternating current, which, after flowing through a commutator unit 117, a controller IC, and a voltage regulator, is converted to a DC current. The DC current in turn charges up the power storage unit 113. As shown in FIGS. 2 and 3, the solar cell units 13 on the two sides are allowed to be removed from the vehicle 1.

Hence, renewable energy is used for generating power and the generated electrical energy is stored and used by the vehicle 1. Also, the present invention not only generates electricity, but also avoids emitting pollutants and greenhouse gas (GHG, i.e. CO₂), thereby achieving the effect of protecting the environment.

Certainly, the shape of each of the solar cell units 13 as well as their mounting locations are not limited by description of the preferred embodiment. For example, a wind-powered generator unit sometimes is also installed on the main vehicle body 11 of the vehicle 1 (not shown in the diagram). The wind-powered generator unit has a plurality of fan blades and a small motor for driving such fan blades. The plurality of solar cell units 13 may include a plurality of solar photovoltaic panels, which are correspondingly installed on the fan blades, thereby integrating different kinds of renewable energy for use. As the above will be easily understood by those skilled in the art, therefore diagrams and description are not further included.

When riding the vehicle 1, the solar cell units 13 on top and two sides of the main vehicle body 11 capture and convert energy from sunlight into electrical energy, which is stored in the power storage unit 113. At the same time, by pedaling the pedal 112, the primary gear 1119 located at the cassette of the rear wheel induces the movement of the gear train 1113 via the transmission part 1115, thereby causing the power generator 1111 to generate an alternating current which, after flowing through the commutator unit 117, the controller IC, and the voltage regulator, is converted to a direct current. The direct current is in turn stored in the power storage unit 113. The vehicle 1, when moving down the slope or pulled across a flat surface without pedaling, is also able to cause the gear-driven power unit 111 to generate electrical energy via the gearing of the gear train 1113, the primary gear 1119, and the transmission part 1115. The generated electrical energy is stored in the power storage unit 113. The accelerator unit 14 is sometimes used for converting electrical energy to mechanical energy to increase the motive force of the main vehicle body 11 at the user's convenience.

When the power storage unit 113 accumulates enough electrical energy, the electrical energy is then supplied to various electrical equipments installed on the vehicle 1, such as the battery power level indicator 114, the LED front light 116, the LED direction light 118, the power supply part 115 in the basket, and the LED brake light 110 at the rear of the bicycle. The power supply part 115 also serves to charge up electrical devices such as PDA, cellular phone, MP3 player, notebook and etc. To protect the above electrical devices from breaking, they are also allowed to be placed in the basket for charging.

Besides, as shown in FIG. 1, the power storage unit 113 further provides the drum-motor-driven power unit 15 with electrical energy for driving the vehicle 1. Belt and chains are not required to gear the vehicle 1 when the drum-motor-driven power unit 15 is used. The advantage of the drum-motor-driven power unit 15 is that it produces less noise, thereby extending the lifetime of the belt and chains. The drum-motor-driven power unit 15 also has the effect of direct transmission, which reduces electrical energy loss. In addition, the vehicle 1 is an electric bicycle with instant charging function, thereby overcoming disadvantages of the electric bicycle currently on the market such as unchargeable power unit and excessive weight.

At the same time, the LED direction light 118 serves as a warning indication to the nearby cars and pedestrians. The LED front light 116 is used at night. In addition, the LED brake light 110 serves as a warning indication to the rear vehicles and pedestrians while braking. Finally, the battery power level indicator 114 constantly monitors the battery power level of the power supply part 115 and checks for power depletion or battery damage. In addition, during summer, the rider is allowed to switch on the fan 1131 to enhance the comfort of riding.

Subsequently, the solar cell unit 13 installed above the main vehicle body 11 serve to block off sunlight on sunny days and prevent the rider from being soaked in rain on rainy days. The solar cell unit 13 installed above the main vehicle body 11 and the supporting rod 1117 are allowed to be removed if not required, thereby lightening the load of the rider.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A power-generating plug-and-play vehicle, comprising:
a main vehicle body having a gear-driven power unit, a power storage unit coupled to the gear-driven power unit, and a plurality of power supply parts electrically connected to the power storage unit; and
a plurality of solar cell units electrically connected to the gear-driven power unit and the power storage unit for capturing and converting solar energy from sunlight into electrical energy which is stored in the power storage unit, wherein the solar cell unit is removable and an angle at which the solar cell unit is installed on the main vehicle body is adjustable; the solar cell units operate in coordination with the gear-driven power unit, so as to allow the main vehicle body to convert wind energy to electrical energy which is in turn stored in the power storage unit; the electrical energy stored in the power storage unit is then supplied to the installed power supply parts.

2. The power-generating plug-and-play vehicle of claim 1, wherein the main vehicle body comprises an arc-shaped supporting rod for supporting one of the solar cell units above the main vehicle body.

3. The power-generating plug-and-play vehicle of claim 1, wherein at least one of two sides of the main vehicle body is installed a mounting part, which is for mounting at least one of the solar cell units on the side of the main vehicle body.

4. The power-generating plug-and-play vehicle of claim 1, wherein the plurality of power supply parts is one of electrical chargers and batteries.

5. The power-generating plug-and-play vehicle of claim 1, wherein the main vehicle body comprises an accelerator unit electrically connected to the power storage unit for converting electrical energy to mechanical energy.

6. The power-generating plug-and-play vehicle of claim 1, wherein the main vehicle body comprises a drum-motor-driven power unit electrically connected to the power storage unit for converting mechanical energy to electrical energy.

7. The power-generating plug-and-play vehicle of claim 1, wherein the gear-driven power unit comprises a power generator, a gear train coupled to the power generator, and a transmission part engaged with the gear train and connected to the main vehicle body.

8. The power-generating plug-and-play vehicle of claim 1 further comprising a pedal mounted to the main vehicle body for driving the transmission part when the pedal is forced to move by an external force.

9. The power-generating plug-and-play vehicle of claim 1, wherein the plurality of solar cell units are solar cell panels.

10. The power-generating plug-and-play vehicle of claim 1 further comprising at least a wind-powered generator unit mounted to the main vehicle body, wherein the wind-power generator unit comprises a plurality of fan blades and a small power generator for driving the fan blades, and the plurality of solar cell units comprise a plurality of solar cell plates installed on the fan blades.

11. The power-generating plug-and-play vehicle of claim 1 further comprising a commutator unit electrically connected to the power storage unit.

12. The power-generating plug-and-play vehicle of claim 1, wherein the power supply parts are capable of charging up electrical equipments external to the main vehicle body.
